(19) United States
(12) Patent Application Publication
(10) Pub. No.: US 2015/0288417 A1
(43) Pub. Date: Oct. 8, 2015

(54) SYSTEM AND METHOD FOR AUTOMATICALLY PAIRING WIRED DEVICES

(71) Applicant: MARVELL WORLD TRADE LTD., St. Michael (BB)

(72) Inventor: Pedro GOMEZ MORENO, Valencia (ES)

(21) Appl. No.: 14/681,210

(22) Filed: Apr. 8, 2015

Related U.S. Application Data
(60) Provisional application No. 61/977,014, filed on Apr. 8, 2014.

(51) Int. Cl. H04B 3/32; H04L 12/911

(52) U.S. Cl. CPC H04B 3/32; H04L 47/70

(57) ABSTRACT

Apparatus, methods, and other embodiments associated with pairing network devices are described. According to one embodiment, a method is performed by a first network device on a data communication network. An identification signal is generated that identifies the first network device. A first transmission frequency is selected that minimizes cross-talk between neighboring wired communication channels of a bundle of wired communication channels. The identification signal is transmitted at the first transmission frequency to a second network device over a first wired communication channel of the bundle of wired communication channels. Pairing the first network device with the second network device is accomplished based on the identification signal. The first transmission frequency is changed to a second transmission frequency that is greater than the first transmission frequency to transmit data to the second network device, subsequent to the pairing, over the first wired communication channel.

### CROSS REFERENCE TO RELATED APPLICATIONS

This patent disclosure claims the benefit of U.S. Provisional Application Ser. No. 61/977,014 filed on Apr. 8, 2014, which is incorporated herein by reference.

### BACKGROUND

As demand for high-speed broadband data to residential homes increases, some telecommunications providers are investing in providing fiber optics all the way to the home. Similarly, some device manufacturers are investing in making home entertainment devices that are compatible with fiber optics to the home. However, providing fiber optics to the home has proven to be an economically expensive proposition. Furthermore, there is much wired legacy infrastructure already in place that reaches all the way to residential homes. Such wired legacy infrastructure includes telephone lines, cable lines, and electrical power lines. One idea is to use this wired legacy infrastructure to provide high-speed broadband data to the home. However, transmitting high-speed broadband signals over such wired legacy infrastructure presents various challenges. One of these challenges is that of correctly pairing customer premises equipment in the home environment with telecommunications provider equipment at a distribution point. Negative effects such as cross-talk between wired communication channels can result in incorrect pairings. Incorrect pairings provide sub-optimal links with poor and unstable performance.

### SUMMARY

In general, in one aspect this specification discloses a first network device that includes transceiver logic configured to be coupled to a first wired communication channel of a bundle of wired communication channels (a bundle). The first network device also includes modulation logic configured to generate an identification signal that identifies the first network device. The modulation logic is also configured to select a first transmission frequency that minimizes cross-talk between neighboring wired communication channels of the bundle of wired communication channels. As this transmission frequency does not cause cross-talk between neighboring wires, this frequency can only be received by a terminating device connected to the same wire in which the transmission was performed. The modulation logic is further configured to transmit, at the first transmission frequency, the identification signal that identifies the first network device to a second network device over the first wired communication channel. The first network device further includes link negotiation logic configured to pair the first network device with the second network device based on the identification signal. The first network device also includes data communication logic configured to select a second transmission frequency that is greater than the first transmission frequency and, subsequent to the first network device being paired to the second network device, transmit data to the second network device, over the first wired communication channel. In one embodiment, the modulation logic is configured to modulate the identification signal with information that includes a media access control address of the first network device. The transceiver logic may be configured to operate as a baseband analog front-end. The data communication logic may be configured to operate as a digital baseband processor. The first network device may be a master device configured to operate in a master-slave relationship with the second network device over the wired communication network. The first network device may be configured to be compatible with a G.hn technology standard. The first transmission frequency may be less than 1 MHz. In one embodiment, the second transmission frequency is greater than 100 MHz. In one embodiment, the second transmission frequency is between 5 MHz and 100 MHz. The wired communication channel may be configured as one of a power line, a coaxial cable, or a telephone line twisted pair.

In general, in another aspect, this specification discloses a method that is performable, for example, by a first network device on a data communication network. The method includes generating an identification signal that identifies the first network device. A first transmission frequency is selected that minimizes cross-talk between neighboring wired communication channels of a bundle of wired communication channels. As this transmission frequency does not cause cross-talk between neighboring wires, this frequency can only be received by a terminating device connected to the same wire in which the transmission was performed. The identification signal is transmitted at the first transmission frequency to a second network device over a first wired communication channel of the bundle of wired communication channels. The first network device pairs with the second network device based on the identification signal. The first transmission frequency is changed to a second transmission frequency that is greater than the first transmission frequency to transmit data to the second network device, subsequent to the pairing, over the first wired communication channel. In one embodiment, the generating of the identification signal includes modulating the identification signal with information that includes a media access control address of the first network device. The pairing of the first network device with the second network device may include the first network device negotiating a communication link with the second network device over the first wired communication channel. In one embodiment, the first transmission frequency is less than 1 MHz. In one embodiment, the second transmission frequency is greater than 5 MHz.

In general, in another aspect, this specification discloses an integrated circuit device. In one embodiment, the integrated circuit device includes transceiver logic configured to be coupled to a wired communication channel of a bundle of wired communication channels (a bundle). The integrated circuit device also includes demodulation logic configured to receive an identification signal over the wired communication channel at a first transmission frequency that minimizes cross-talk between neighboring wired communication channels of the bundle of wired communication channels. As this transmission frequency does not cause cross-talk between neighboring wires, this frequency can only be received by a terminating device connected to the same wire in which the transmission was performed. The demodulation logic is also configured to extract information from the identification signal that identifies a master device operatively connected to the wired communication channel. The integrated circuit device further includes link negotiation logic configured to pair with the master device based on the identification signal. In one embodiment, the integrated circuit device is configured to be compatible with a G.hn technology standard. In one embodiment, the first transmission frequency is less than 1 MHz. In one embodiment, the integrated circuit device includes data communication logic configured to receive a data communication signal from the master device over the wired communication channel at a second transmission frequency in accordance with a data communication protocol, and extract data from the data communication signal. In one embodiment, the second transmission frequency is greater than 5 MHz.

### BRIEF DESCRIPTION OF THE DRAWINGS

The accompanying drawings, which are incorporated in and constitute a part of the specification, illustrate various systems, methods, and other embodiments of the disclosure. Illustrated element boundaries (e.g., boxes, groups of boxes, or other shapes) in the figures represent one example of the boundaries. In some examples one element may be designed as multiple elements or multiple elements may be designed as one element. In some examples, an element shown as an internal component of another element may be implemented as an external component and vice versa.

FIG. 1 illustrates one embodiment of a data communication network configured to automatically and correctly communicatively pair slave network devices with master network devices to which the slave network devices are wired.

FIG. 2 illustrates one embodiment of a master network device of the data communication network of FIG. 1.

FIG. 3 illustrates one embodiment of a slave network device of the data communication network of FIG. 1.

FIG. 4 illustrates one embodiment of a method, performable by the slave network device of FIG. 3, for automatically and correctly pairing to the master network device of FIG. 2.

FIG. 5 illustrates one embodiment of a method, performable by the master network device of FIG. 2, for automatically and correctly pairing to the slave network device of FIG. 3.

FIG. 6 illustrates one embodiment of the slave network device of FIG. 3 implemented as an integrated circuit device.

### DETAILED DESCRIPTION

Described herein are examples of systems, apparatus, methods, and other embodiments associated with correctly pairing two wired network devices on a data communication network. That is, embodiments are described herein that are associated with preventing an incorrect pairing of two wired network devices on a data communication network due to wire-to-wire cross-talk on the network. The term “cross-talk”, as used herein, refers to the unwanted transfer of signals between wired communication channels. Such unwanted transfer of signals usually occurs via radio frequency propagation through a medium between the wired communication channels. The term “wired communication channel” (or “wire” for short), as used herein, refers to one or more electrically conductive wires (e.g., copper wires) that are physically connected between two network devices in a data communication network for the purpose of transferring electrical data communication signals between the two network devices. Some examples of wired communication channels include coaxial cables or twisted pair wires connected between two network devices.

In one embodiment, a master network device (a first device) transmits a modulated low frequency signal to a slave network device (a second device) to which the master network device is communicatively wired via a wired communication channel. The modulated low frequency signal is an identification signal having identification information that identifies the master network device to the slave network device.

In one embodiment, the master network device generates the frequency of the identification signal to be low enough such that cross-talk does not occur (or is at least minimized) over neighboring cables. Thus, only the slave device that is physically wired to the master network device will receive the identification signal. In this manner, the slave network device knows which master network device to which the slave network device is physically wired. Furthermore, the slave network device knows to link to and communicate with only the master network device associated with the identification information.

The communicative pairing of the master network device and the slave network device is performed automatically based at least in part on using the low frequency signal. In this manner, time-consuming manual verifications of correct pairings do not need to be performed, for example, by a technician in the field. Furthermore, less reliable methods such as, for example, channel frequency response (CFR) methods do not need to be performed.

The terms “master network device”, “master device”, “header device”, and “master header device” are used interchangeably herein.

The terms “slave network device”, “slave device”, “terminator device”, and “slave terminator device” are used interchangeably herein.

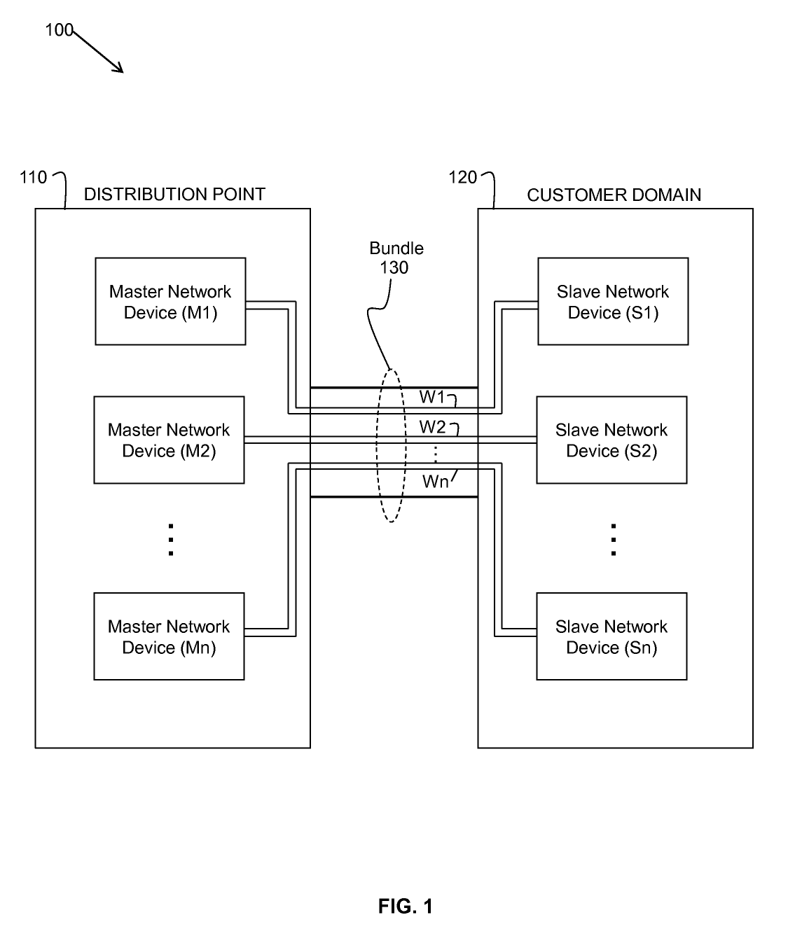

FIG. 1 illustrates one embodiment of a data communication network 100 configured to automatically and correctly communicatively pair slave network devices with master network devices to which the slave network devices are physically wired. The communication network 100 includes a distribution point 110, a customer domain 120, and a bundle of wires 130 (a bundle of wired communication channels). The terms “bundle of wired communication channels”, “bundle of wires”, or “bundle”, as used herein, refer to two or more wired communication channels which are routed in close proximity to each other, at least for some minimal distance, between respective pairs of network devices. The close proximity may allow for the possibility of channel-to-channel interference (i.e., cross-talk) to occur. For example, multiple twisted pair wires may be configured as a cable, where the multiple twisted pair wires are gathered together, next to each other, within a cable sheath or covering. The distribution point 110 includes a plurality of “n” master network devices (e.g., M1, M2, to Mn, where “n” is a positive integer number (e.g., 24). In one embodiment, the distribution point 110 is configured as a G.hn access multiplexer. The customer domain 120 includes a plurality of “n” slave network devices (e.g., S1, S2, to Sn). In one embodiment, the customer domain 120 is configured as a G.hn network termination. The bundled wires 130 includes a plurality of wires that form wired communication channels (e.g., W1, W2 . . . Wn).

The following discussion is based on the following example configuration. Each master network device is physically wired to a corresponding slave network device via a wired communication channel in the bundled wires 130. For example, M1 is physically wired to S1, M2 is physically wired to S2, and Mn is physically wired to Sn. The customer domain 120 may be, for example, an apartment building where each slave network device is installed in a separate apartment of the apartment building. The distribution point 110 may be, for example, a building of a telecommunications company which houses the master network devices. The bundle of wires 130 are cables that run from the distribution point 110 to the customer domain 120. Each master device M1 . . . Mn includes at least one port for connecting to one of the wires W1 . . . Wn. Likewise, each slave device S1 . . . Sn includes at least one port for connecting to one of the wires W1 . . . Wn. In one embodiment, a slave device S1 . . . Sn is connected to the bundle of wires 130 when the slave device is installed as part of receiving a service from the distribution point. For example, the slave device may be a cable box that is installed in a customer's home and connected to a cable company via the bundle of wires 130. At the other end, one of the master devices is connected to the same cable wire. Thus master device M1 is connected to slave device S1 via wire W1.

Prior to operating with each other, the master network device M1 and the connected slave device S1 need to be paired together and establish a communication link. However, since the bundle of wires 130 run side-by-side to each other, cross-talk between the wires may occur. This may cause a slave device to receive signals from a master device with which the slave device is not connected. For example, slave device S2 may receive signals sent from master device M1 due to cross-talk even though slave device S2 is directly connected to master device M2 via wire W2. As a result, slave device S2 may believe it is connected with master device M1 and attempt to pair with M1, which is an error.

To reduce or eliminate the cross-talk issue and incorrect pairing, the master device M1 is configured to generate an identification signal and transmit the signal at a low frequency across wire W1. The low frequency is selected to be low enough (below normal operating frequencies) so that cross-talk is minimized or does not occur to other wires in the bundle of wires 130. If normal operation frequency is 5 MHz to 100 MHz, then the selected low frequency may be about 1 MHz or less. Accordingly, only the slave device S1 connected to wire W1 will receive the identification signal of master device M1. Thus after the slave device S1 receives the correct identification signal from only its master M1, an automatic pairing operation is performed by the two devices so that a correct pairing between the two devices is established.

This identification mechanism allows the pairing to be performed automatically by the two devices with a very high reliability that they are pairing with only directly connected master-slave devices. This reduces or eliminates the need for using skilled technicians in the field to manually pair a slave device to its corresponding master due to cross-talk issues. The present automatic procedure also makes it feasible to have massive field installation of many slave devices (e.g., G.now slaves) at end customer premises.

After the two devices are paired, normal operation can begin and the master device changes its frequency for signal transmission. During normal operation, a master network device provides data (e.g., high-speed broadband data for high-definition internet television content) to a corresponding slave network device over a corresponding wired communication channel. In one embodiment, the master network device is a header device and the slave network device is a terminator device. A master network device and a slave network device communicate with each other in a master-slave relationship over the wired communication channel. A wired communication channel may be configured as, for example, one of a coaxial cable, an AC power line, or a telephone line twisted pair.

In some embodiments, the slave network devices S1 . . . Sn may be a CPE device (Customer Premises Equipment) that is telecommunications hardware located at a customer location. The slave device may include cable or satellite television set-top boxes, digital subscriber line (DSL) or other broadband Internet routers, VoIP base stations, telephone handsets or other customized hardware used by a telecommunications service provider.

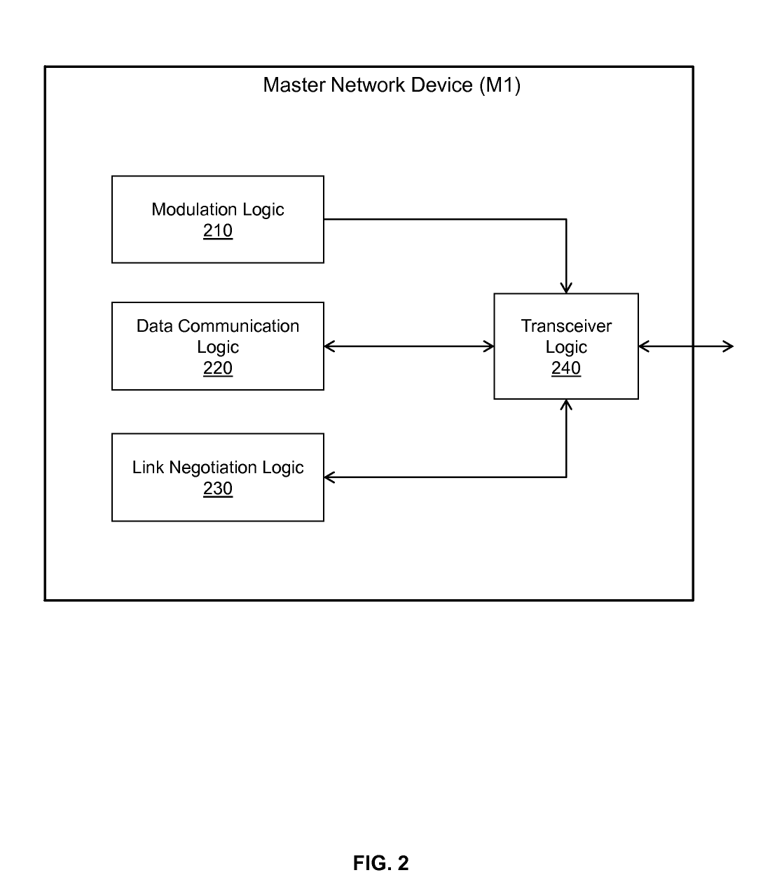

FIG. 2 illustrates one embodiment of the master network device M1 of FIG. 1. The master network device M1 includes modulation logic 210, data communication logic 220, link negotiation logic 230, and transceiver logic 240. The other master devices M2 . . . Mn may be similarly configured. The master network device M1 is configured to operate in a master-slave relationship with the slave network device S1 over the wired communication channel W1. In one embodiment, the master network device M1 is configured to be compatible with a G.hn technology standard.

In one embodiment, the master network device M1 is implemented on a chip (i.e., a system-on-chip or SOC configuration) including one or more integrated circuits configured to perform one or more of the functions described herein. In another embodiment, the logics of the master network device M1 may be part of an executable algorithm configured to perform the functions of the logics where the algorithm is stored in a non-transitory medium.

Referring to FIG. 2, the transceiver logic 240 is configured to transmit and receive electrical signals over the wired communication channel W1 of a bundle of wired communication channels (a bundle) 130. In one embodiment, at least some of the electrical signals are in the form of a data communication signal. Furthermore, in one embodiment, the transceiver logic 240 is configured to operate as a baseband analog front-end.

The modulation logic 210 is configured to operatively interact with the transceiver logic 240 to generate an identification signal, that identifies a network device (e.g., a master device), and select a first transmission frequency. The first transmission frequency is a low frequency (e.g., less than 1 MHz) that does not cause cross-talk between neighboring wired communication channels of the bundle of wired communication channels. The low frequency of the modulation identification signal mitigates cross-talk from the wired communication channel W1 to other wired communication channels (e.g., W2 to Wn) of the bundle of wires 130. Transmitting the identification signal using the low frequency reduces the chances that other slave devices S2 . . . Sn, which are not directly connected to master device M1, receive the identification signal in error via cross-talk.

The modulation logic 210 is also configured to operatively interact with the transceiver logic 240 to transmit the identification signal at the first transmission frequency to a slave device over the first wired communication channel. In one embodiment, the modulation logic 210 is configured to modulate the identification signal with identification information that includes a media access control (MAC) address of the network device.

The link negotiation logic 230 is configured to operatively interact with the transceiver logic 240 to perform a pairing operation with the slave device based on the identification signal. For example, the link negotiation logic 230 is configured to operatively interact with the transceiver logic 240 to negotiate a communication link between the master network device M1 and the slave network device S1 over the wired communication channel W1. Once the communication link is negotiated, the master network device M1 may communicate data to the slave network device S1 over the wired communication channel W1 at a high data rate (e.g., 800 Mbps). Furthermore, in one embodiment, the master network device M1 may receive data from the slave network device S1 over the wired communication channel W1.

The data communication logic 220 is configured to operatively interact with the transceiver logic 240 to select a second transmission frequency (e.g., between 5 MHz and 100 MHz, or greater than 100 MHz) that is greater than the first transmission frequency. The data communication logic 220 is also configured to operatively interact with the transceiver logic 240 to transmit data to the slave device, after the pairing operation, over the wired communication channel. In one embodiment, the data communication logic 220 is configured to operate as a digital baseband processor. Such a digital baseband processor may include a central processing unit, serial interfaces, and support a G.hn physical layer (PHY), a G.hn media access control (MAC) layer, and a G.hn data link layer (DLL).

In one embodiment, the data communication logic 220 is configured to operatively interact with the transceiver logic 240 to format (e.g., encode) and transmit data as a data communication signal over the wired communication channel W1. Data is transmitted at a transmission frequency (e.g., between 5 MHz and 100 MHz) in accordance with a data communication protocol (e.g. a Gigabit Ethernet protocol that is compatible with the G.hn standard).

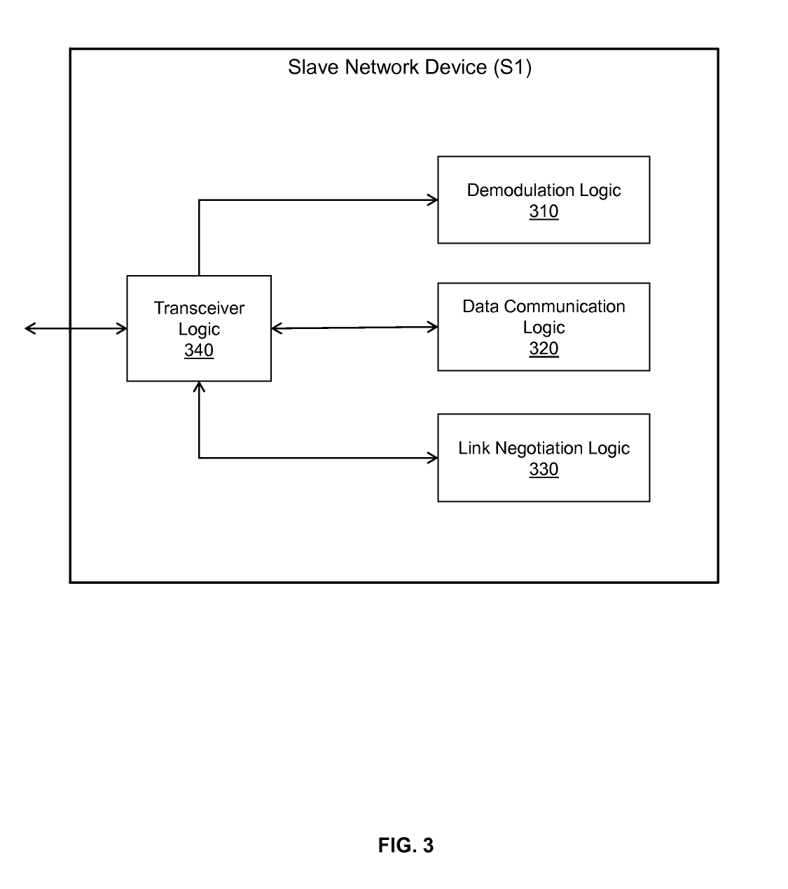

FIG. 3 illustrates one embodiment of an apparatus (e.g., a slave network device S1) of the data communication network 100 of FIG. 1. The slave network device S1 includes demodulation logic 310, data communication logic 320, link negotiation logic 330, and transceiver logic 240. The slave network device S1 is configured to operate in a master-slave relationship with the master network device M1 over the wired communication channel W1. In one embodiment, the slave network device S1 is configured to be compatible with a G.hn technology standard.

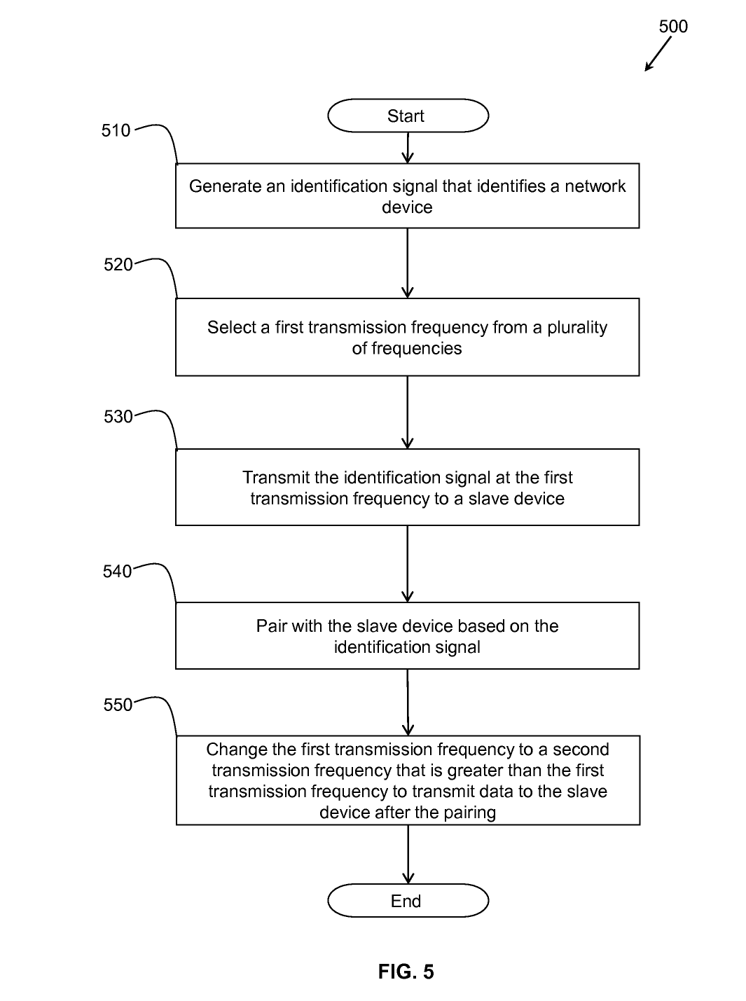

In one embodiment, the slave network device S1 is implemented on a chip (i.e., a system-on-chip or SOC configuration) including one or more integrated circuits configured to perform one or more of the functions described herein (see FIG. 5). In another embodiment, the logics of the slave network device S1 may be part of an executable algorithm configured to perform the functions of the logics where the algorithm is stored in a non-transitory medium.

Referring to FIG. 3, the transceiver logic 340 is configured to transmit and receive electrical signals over the wired communication channel W1 of the bundle of wired communication channels (the bundle) 130. In one embodiment, at least some of the electrical signals are in the form of a data communication signal. Furthermore, in one embodiment, the transceiver logic 340 is configured to operate as a baseband analog front-end.

The data communication logic 320 is configured to operatively interact with the transceiver logic 240 to receive a data communication signal over the wired communication channel W1 and extract (e.g., decode) data from the data communication signal. Data is received at a transmission frequency (e.g., between 5 MHz and 100 MHz) in accordance with a data communication protocol (e.g. a Gigabit Ethernet protocol that is compatible with the G.hn standard). In one embodiment, the data communication logic 320 is configured to operate as a digital baseband processor. Such a digital baseband processor may include a central processing unit, serial interfaces, and support a G.hn physical layer (PHY), a G.hn media access control (MAC) layer, and a G.hn data link layer (DLL).

The demodulation logic 310 is configured to operatively interact with the transceiver logic 340 to receive and demodulate (extract identification information from) an identification signal having identification information which identifies the master network device M1. The identification signal is transmitted over the wired communication channel W1 to the slave network device S1. The identification signal is a low frequency signal (e.g., having a transmission frequency of less than 1 MHz). The low frequency of the identification signal mitigates cross-talk from the wired communication channel W1 to other wired communication channels (e.g., W2 to Wn) of the bundle 130.

The link negotiation logic 330 is configured to operatively interact with the transceiver logic 340 to initiate a link negotiation with the master network device M1 and negotiate a communication link between the master network device M1 and the slave network device S1 over the wired communication channel W1. For example, in one embodiment, the link negotiation logic 330 of the slave network device S1 negotiates the communication link with the link negotiation logic 230 of the master network device M1. The transmission frequency of the link negotiation (e.g., 2 MHz) may be between the transmission frequency of the identification signal (e.g., less than 1 MHz) and the transmission frequency of normal data communications (e.g., 5 MHz to 100 MHz).

The slave network device S1 “knows” to initiate negotiation with the master network device M1 based on the identification information. Once the communication link is negotiated, the slave network device S1 may receive data from the master network device M1 over the wired communication channel W1 at a high data rate (e.g., 800 Mbps). Furthermore, in one embodiment, the slave network device S1 may transmit data to the master network device M1 over the wired communication channel W1.

In this manner, a slave network device in a customer environment can correctly link to (i.e., pair with) a corresponding master network device to which the slave network device is physically wired. Since identification of a master network device to a corresponding slave network device is accomplished via a low frequency identification signal, it can be ensured that cross-talk effects will not result in an incorrect pairing.

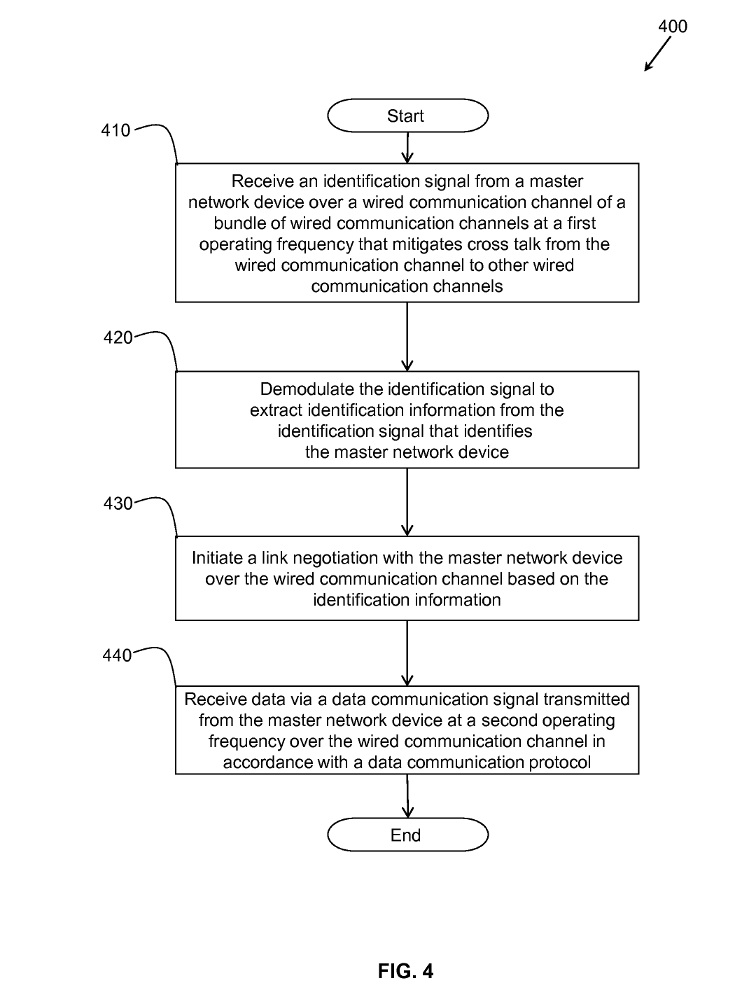

FIG. 4 illustrates one embodiment of a method 400, performable by the slave network device S1 of FIG. 3, for automatically and correctly pairing to the master network device M1 of FIG. 2. Method 400 is implemented to be performed by the apparatus S1 (slave network device) of FIG. 3, or by a computing device (e.g., an integrated circuit device) configured with an algorithm of method 400. Method 400 will be described from the perspective that the apparatus (or the computing device) is a slave network device (e.g., a slave terminator device) operable to connect to a master network device (e.g., a master header device) over a wired communication channel (e.g., a telephone line twisted pair). In one embodiment, the wired communication channel is in a G.hn-compatible data communication network.

Method 400 starts when a slave network device attempts to pair with a master network device in a data communication network. The master network device may be one of many master network devices (e.g., header devices) residing at a distribution point provided by a telecommunications company. The slave network device may be one of many slave network devices (e.g., customer premises equipment) residing in a customer environment.

Upon initiating method 400 at 410, an identification signal is received from a master network device over a wired communication channel. The wired communication channel exists in a bundle among a plurality of other wired communication channels. The identification signal has a first transmission frequency that is low enough to mitigate cross-talk from the wired communication channel to any other wired communication channel of the bundle. Therefore, the identification signal will be received only by a network device that is physically wired to the wired communication channel (e.g., a slave network device). In one embodiment, the transceiver logic 340 is configured to perform 410.

Once the identification signal is received at 410, at 420 the identification signal is demodulated to extract identification information from the identification signal. The identification information identifies the master network device which sent the identification signal. In one embodiment, the identification information is a media access control (MAC) address of the master network device. The demodulation logic 310 is configured to perform 420, in one embodiment.

At 430, a link negotiation is initiated with the master network device based on the identification information. The link negotiation is initiated over the wired communication channel and is configured to establish a data communication link with the master network device at a second transmission frequency in accordance with a data communication protocol. The second transmission frequency (e.g., 100 MHz) of the data communication link is greater than the first transmission frequency (e.g., 500 KHz) of the identification signal. Furthermore, in one embodiment, the transmission frequency at which the link negotiation takes place is between the first transmission frequency and the second transmission frequency. For example, the transmission frequency at which the link negotiation takes place may be 3 MHz. The link negotiation logic 330 is configured to operatively interact with the transceiver logic 340 to perform 430, in accordance with one embodiment.

At 440, data is received via a data communication signal transmitted from the master network device over the wired communication channel. The data communication signal is transmitted at the second transmission frequency (e.g., 100 MHz) in accordance with the data communication protocol of the established data communication link. For example, the data communication signal may contain data associated with one of the following applications: high definition internet protocol television (HD-IPTV), voice over internet protocol (VoIP), gaming content, video surveillance, or multi-room digital video recording (DVR). In one embodiment, the data communication logic 320 is configured to operatively interact with the transceiver logic 340 to perform 440.

FIG. 5 illustrates one embodiment of a method 500, performable by the master network device M1 of FIG. 2, for automatically and correctly pairing to the slave network device S1 of FIG. 3. Method 500 is implemented to be performed by the apparatus M1 (master network device) of FIG. 2, or by a computing device (e.g., an integrated circuit device) configured with an algorithm of method 500. Method 500 will be described from the perspective that the apparatus (or the computing device) is a master network device (e.g., a master header device) operable to connect to a slave network device (e.g., slave terminator device) over a wired communication channel (e.g., a telephone line twisted pair). In one embodiment, the wired communication channel is in a G.hn-compatible data communication network.

Method 500 starts when a master network device generates a signal to be transmitted to a slave network device in a data communication network. The master network device may be one of many master network devices (e.g., header devices) residing at a distribution point provided by a telecommunications company. The slave network device may be one of many slave network devices (e.g., customer premises equipment) residing in a customer environment.

Upon initiating method 500 at 510, an identification signal is generated that identifies a network device (e.g., the master device M1). In one embodiment, generating the identification signal includes modulating the identification signal with identification information that identifies the network device. For example, in one embodiment, the identification information includes a media access control (MAC) address of the network device (e.g., the master device M1). The modulation logic 210 is configured to operatively interact with the transceiver logic 240 to perform block 510, in one embodiment.

At 520, a first transmission frequency is selected from a plurality of frequencies. The first transmission frequency is a low frequency that does not cause cross-talk between neighboring wired communication channels of a bundle of wired communication channels. For example, in one embodiment, the first transmission frequency is less than 1 MHz. At 530, the identification signal is transmitted at the first transmission frequency to a slave device (e.g., slave network device S1). The first transmission frequency is transmitted over a first wired communication channel (e.g., W1) of the bundle of wired communication channels (e.g., 130). The modulation logic 210 is configured to operatively interact with the transceiver logic 240 to perform 520 and 530, in one embodiment.

At 540, pairing to the slave device is performed based on the identification signal. For example, in one embodiment, pairing to the slave device includes the network device (e.g., the master device M1) negotiating a communication link with the slave device (e.g., S1) over the first wired communication channel (e.g., W1). The link negotiation logic 230 is configured to operatively interact with the transceiver logic 240 to perform 540, in one embodiment. The pairing is initiated by the slave device, in accordance with one embodiment. The pairing is initiated by the master device, in accordance with another embodiment.

At 550, the first transmission frequency is changed to a second transmission frequency to transmit data to the slave device after the pairing. The data is transmitted over the first wired communication channel to the slave device via the negotiated communication link. The second transmission frequency is greater than the first transmission frequency. For example, in one embodiment, the first transmission frequency is less than 1 MHz and the second transmission frequency is between 5 MHz and 100 MHz. In another embodiment, the second transmission frequency is greater than 100 MHz. The data communication logic 220 is configured to operatively interact with the transceiver logic 240 to perform 550, in accordance with one embodiment.

In this manner, legacy wired infrastructure may be used for high-speed broadband transmission of data from a distribution point all the way to a terminator device in the home. Header devices at a distribution point can be correctly paired with terminator devices in a customer environment such that the negative effects of cross-talk between wired communication channels is mitigated. By identifying a master network device (e.g., a header device) to a slave network device (e.g., a terminator device) through a low frequency modulated signal, the slave network device can know to communicate only with the master network device.

### Integrated Circuit Device Embodiment

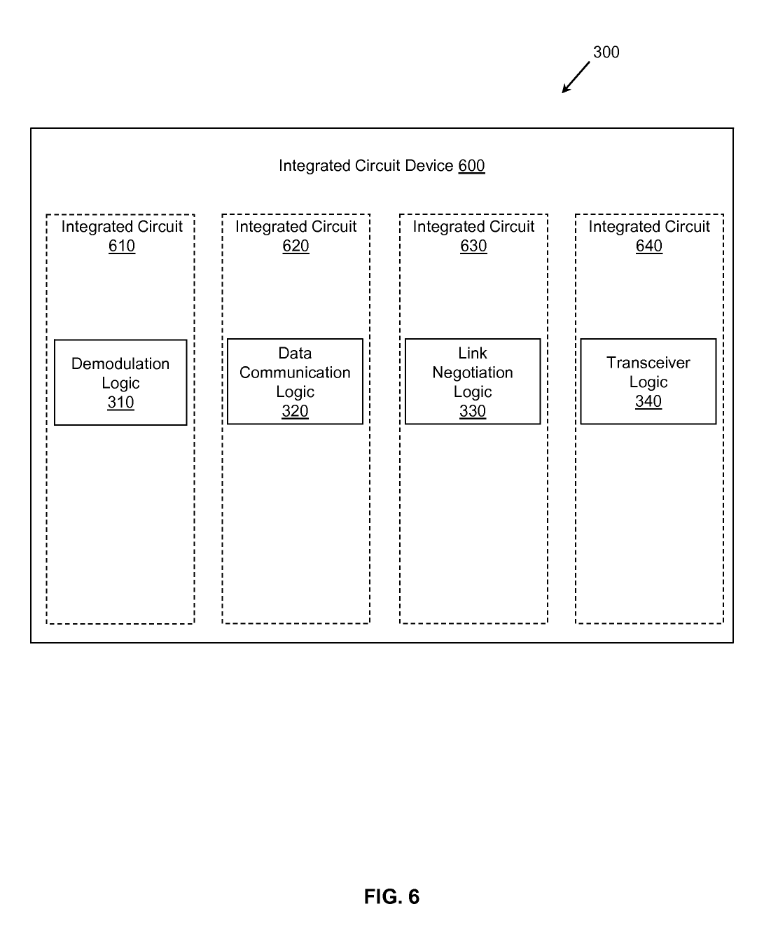

FIG. 6 illustrates one embodiment of the slave network device S1 of FIG. 3 implemented as an integrated circuit device 600. In this embodiment, the demodulation logic 310, the data communication logic 320, the link negotiation logic 330, and the transceiver logic 340 are each embodied as a separate integrated circuit 610, 620, 630, and 640, respectively. In one embodiment, the integrated circuit device 600 is configured to be compatible with a G.hn technology standard.

The circuits are connected via connection paths to communicate signals. While integrated circuits 610, 620, 630, and 640 are illustrated as separate integrated circuits, they may be integrated into a common integrated circuit device 600. Additionally, integrated circuits 610, 620, 630, and 640 may be combined into fewer integrated circuits or divided into more integrated circuits than illustrated.

In another embodiment, the demodulation logic 310, the data communication logic 320, the link negotiation logic 330, and the transceiver logic 340 (which are illustrated in integrated circuits 610, 620, 630, and 640, respectively) may be combined into a separate application-specific integrated circuit. In other embodiments, portions of the functionality associated with the demodulation logic 310, the data communication logic 320, the link negotiation logic 330, and the transceiver logic 340 may be embodied as firmware executable by a processor and stored in a non-transitory memory (e.g., a non-transitory computer storage medium).

Systems, methods, and other embodiments associated with correctly pairing two network devices on a data communication network have been described. According to one embodiment, an apparatus includes transceiver logic, data communication logic, and modulation logic. The transceiver logic is configured to transmit and receive electrical signals over a wired communication channel of a bundle of wired communication channels. The data communication logic is configured to operatively interact with the transceiver logic to format and transmit data as a data communication signal over the wired communication channel at a first transmission frequency in accordance with a data communication protocol. The modulation logic is configured to operatively interact with the transceiver logic to generate an identification signal that is modulated with identification information. The identification information identifies the apparatus on the network. The modulation logic is also configured to operatively interact with the transceiver logic to transmit the identification signal over the wired communication channel at a second transmission frequency. The second transmission frequency is lower than the first transmission frequency and mitigates cross-talk from the wired communication channel to other wired communication channels of the bundle of wired communication channels during transmission of the identification signal.

### DEFINITIONS AND OTHER EMBODIMENTS

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

“Computer-readable medium” or “computer storage medium”, as used herein, refers to a non-transitory medium that stores instructions and/or data configured to perform one or more of the disclosed functions when executed. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an application specific integrated circuit (ASIC), a programmable logic device, a compact disk (CD), other optical medium, a random access memory (RAM), a read only memory (ROM), a memory chip or card, a memory stick, solid state storage device (SSD), flash drive, and other media from which a computer, a processor or other electronic device can function with. Each type of media, if selected for implementation in one embodiment, may include stored instructions of an algorithm configured to perform one or more of the disclosed and/or claimed functions. Computer-readable media described herein are limited to statutory subject matter under 35 U.S.C §101.

“Logic”, as used herein, represents a component that is implemented with computer or electrical hardware, a non-transitory medium with stored instructions of an executable application or program module, and/or combinations of these to perform any of the functions or actions as disclosed herein, and/or to cause a function or action from another logic, method, and/or system to be performed as disclosed herein. Equivalent logic may include firmware, a microprocessor programmed with an algorithm, a discrete logic (e.g., ASIC), at least one circuit, an analog circuit, a digital circuit, a programmed logic device, a memory device containing instructions of an algorithm, and so on, any of which may be configured to perform one or more of the disclosed functions. In one embodiment, logic may include one or more gates, combinations of gates, or other circuit components configured to perform one or more of the disclosed functions. Where multiple logics are described, it may be possible to incorporate the multiple logics into one logic. Similarly, where a single logic is described, it may be possible to distribute that single logic between multiple logics. In one embodiment, one or more of these logics are corresponding structure associated with performing the disclosed and/or claimed functions. Choice of which type of logic to implement may be based on desired system conditions or specifications. For example, if greater speed is a consideration, then hardware would be selected to implement functions. If a lower cost is a consideration, then stored instructions/executable application would be selected to implement the functions. Logic is limited to statutory subject matter under 35 U.S.C. §101.

An “operable (or operative) connection”, or a connection by which entities are “operably (or operatively) connected”, is one in which signals, physical communications, and/or logical communications may be sent and/or received. An operable connection may include a physical interface, an electrical interface, and/or a data interface. An operable connection may include differing combinations of interfaces and/or connections sufficient to allow operable control. For example, two entities can be operably connected to communicate signals to each other directly or through one or more intermediate entities (e.g., processor, operating system, logic, non-transitory computer-readable medium). An operable connection may include one entity generating data and storing the data in a memory, and another entity retrieving that data from the memory via, for example, instruction control. Logical and/or physical communication channels can be used to create an operable connection. The terms “operable” and “operative”, and there various forms, may be used interchangeably herein.

“Operable interaction” or “operative interaction”, and there various forms as used herein, refers to the logical or communicative cooperation between two or more logics via an operable (operative) connection to accomplish a function.

While for purposes of simplicity of explanation, illustrated methodologies are shown and described as a series of blocks. The methodologies are not limited by the order of the blocks as some blocks can occur in different orders and/or concurrently with other blocks from that shown and described. Moreover, less than all the illustrated blocks may be used to implement an example methodology. Blocks may be combined or separated into multiple components. Furthermore, additional and/or alternative methodologies can employ additional actions that are not illustrated in blocks. The methods described herein are limited to statutory subject matter under 35 U.S.C §101.

To the extent that the term “includes” or “including” is employed in the detailed description or the claims, it is intended to be inclusive in a manner similar to the term “comprising” as that term is interpreted when employed as a transitional word in a claim.

To the extent that the term “or” is used in the detailed description or claims (e.g., A or B) it is intended to mean “A or B or both”. When the applicants intend to indicate “only A or B but not both” then the phrase “only A or B but not both” will be used. Thus, use of the term “or” herein is the inclusive, and not the exclusive use.

To the extent that the phrase “one or more of, A, B, and C” is used herein, (e.g., a data store configured to store one or more of, A, B, and C) it is intended to convey the set of possibilities A, B, C, AB, AC, BC, and/or ABC (e.g., the data store may store only A, only B, only C, A&B, A&C, B&C, and/or A&B&C). It is not intended to require one of A, one of B, and one of C. When the applicants intend to indicate “at least one of A, at least one of B, and at least one of C”, then the phrasing “at least one of A, at least one of B, and at least one of C” will be used.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or the illustrative examples shown and described. Thus, this disclosure is intended to embrace alterations, modifications, and variations that fall within the scope of the appended claims.

What is claimed is:

1. A first network device comprising:
transceiver logic configured to be coupled to a first wired communication channel of a bundle of wired communication channels;
modulation logic configured to
(i) generate an identification signal that identifies the first network device,
(ii) select a first transmission frequency that minimizes cross-talk between neighboring wired communication channels of the bundle of wired communication channels, and
(iii) transmit, at the first transmission frequency, the identification signal that identifies the first network device to a second network device over the first wired communication channel;
link negotiation logic configured to pair the first network device with the second network device based on the identification signal; and
data communication logic configured to (i) select a second transmission frequency that is greater than the first transmission frequency, and (ii) subsequent to the first network device being paired to the second network device, transmit data at the second transmission frequency to the second network device over the first wired communication channel.

2. The first network device of claim 1, wherein the modulation logic is configured to modulate the identification signal with information that includes a media access control address of the first network device.

3. The first network device of claim 1, wherein the transceiver logic is configured to operate as a baseband analog front-end.

4. The first network device of claim 1, wherein the data communication logic is configured to operate as a digital baseband processor.

5. The first network device of claim 1, wherein the first network device is a master device configured to operate in a master-slave relationship with the second network device over the wired communication channel.

6. The first network device of claim 1, wherein the first network device is configured to be compatible with a G.hn technology standard.

7. The first network device of claim 1, wherein the first transmission frequency is less than 1 MHz.

8. The first network device of claim 1, wherein the second transmission frequency is greater than 100 MHz.

9. The first network device of claim 1, wherein the second transmission frequency is between 5 MHz and 100 MHz.

10. The first network device of claim 1, wherein the wired communication channel is configured as one of a power line, a coaxial cable, or a telephone line twisted pair.

11. A method comprising:
generating an identification signal that identifies a first network device;
selecting a first transmission frequency that minimizes cross-talk between neighboring wired communication channels of a bundle of wired communication channels;
transmitting, at the first transmission frequency, the identification signal to a second network device over a first wired communication channel of the bundle of wired communication channels;
pairing the first network device with the second network device based on the identification signal; and
changing the first transmission frequency to a second transmission frequency that is greater than the first transmission frequency to transmit data to the second network device, subsequent to the pairing, over the first wired communication channel.

12. The method of claim 11, wherein the generating of the identification signal includes modulating the identification signal with information that includes a media access control address of the first network device.

13. The method of claim 11, wherein the pairing of the first network device with the second network device includes the first network device negotiating a communication link with the second network device over the first wired communication channel.

14. The method of claim 11, wherein the first transmission frequency is less than 1 MHz.

15. The method of claim 11, wherein the second transmission frequency is greater than 5 MHz.

16. An integrated circuit device, the integrated circuit device comprising:
transceiver logic configured to be coupled to a wired communication channel of a bundle of wired communication channels;
demodulation logic configured to:
(i) receive an identification signal over the wired communication channel at a first transmission frequency that minimizes cross-talk between neighboring wired communication channels of the bundle of wired communication channels, and
(ii) extract information from the identification signal that identifies a master device operatively connected to the wired communication channel; and
link negotiation logic configured to pair with the master device based on the identification signal.

17. The integrated circuit device of claim 16, wherein the integrated circuit device is configured to be compatible with a G.hn technology standard.

18. The integrated circuit device of claim 16, wherein the first transmission frequency is less than 1 MHz.

19. The integrated circuit device of claim 16, further comprising data communication logic configured to:
receive a data communication signal from the master device over the wired communication channel at a second transmission frequency in accordance with a data communication protocol; and
extract data from the data communication signal.

20. The integrated circuit device of claim 19, wherein the second transmission frequency is greater than 5 MHz.
